(19) United States
(12) Patent Application Publication
(10) Pub. No.: US 2006/0116857 A1
(43) Pub. Date: Jun. 1, 2006

(54) Method and apparatus for model extraction

(76) Inventors: John F. Sevic, Los Gatos, CA (US); Gary R. Simpson, Fontana, CA (US)

Correspondence Address: LAW OFFICES OF LARRY K. ROBERTS, INC., 2 Park Plaza, Suite 300, Irvine, CA, 92614, US

(21) Appl. No.: 11/001,692

(22) Filed: Nov. 30, 2004

(51) Int. Cl. G06F 17/50

(52) U.S. Cl. 703/13

(57) ABSTRACT

A method and apparatus for extracting a model of a device under test (DUT), wherein an extraction-space protocol is defined, a set of measurement data on the DUT is extracted in accordance with the extraction-space protocol, and a DUT model extracted from the set of measurement data collected over the extraction-space, corresponding to a combination of parameters within the extraction-space.

### BACKGROUND

Modeling of RF/microwave transistors has traditionally been based on development of an equivalent circuit model and fitting measured DC (direct current) and CV (capacitive voltage) parameters to constitutive relations for each of the model elements. For example, the Gummel-Poon model uses constitutive relations derived from basic BJT (bipolar junction transistor) physics; its parameters are fit using a combination of DC and CV (from s-parameter) measurements. Alternatively, analytical constitutive relations can be derived by heuristic methods from which approximate physical relations are obtained. An example of this approach is the Curtice MESFET (metal semiconductor filed effect transistor) model. While there may be alternative methods of describing the constitutive relations, even using neural networks, for example, the central theme is identification of an equivalent circuit model of the “DUT.” DUT refers to “Device Under Test,” which is the device or system, e.g. a transistor, whose model is to be extracted. A system can be an interconnection of transistors, or even a passive element.

These methods include identification of an equivalent circuit model and subsequent extraction of parameters to describe the relationship between the independent and dependent variables of each of the equivalent circuit elements comprising the DUT model. The equivalent circuit model should represent as close as possible a physical essence of the DUT, including the solid-state transistor physics, its physical layout, its parasitic elements, its electrodynamic effects and electrothermal effects, and package effects. In addition, in the event that the DUT is electrically large, network descriptions may be used to properly model the effect of distributed effects. If the DUT is a system, then other considerations may be important, such as identification of control variables.

### BRIEF DESCRIPTION OF THE DRAWINGS

Features and advantages of the disclosure will readily be appreciated by persons skilled in the art from the following detailed description when read in conjunction with the drawing wherein:

FIG. 1 is a schematic block diagram of an exemplary embodiment of a generalized impedance control apparatus along with stimulus hardware, measurement and control hardware, data collection hardware, control hardware, and the DUT.

FIG. 2 illustrates a DUT is shown with m stimulus ports and n response ports, as a representation of a generalization of a “black-box” behavioral model.

FIG. 3 shows a typical extraction-space protocol.

FIG. 4 illustrates an exemplary embodiment of a source power sweep executed for different combinations of source impedance and load impedance.

FIG. 5 shows an exemplary method of extraction, with an abstract extraction-space, including elements that represent each of several possible combinations.

FIG. 6 is a diagrammatic illustration of an exemplary model extraction process.

FIG. 7 illustrates an exemplary model selection algorithm.

FIG. 8A illustrates a simplified schematic block diagram of a typical GSM cellular telephone handset. FIG. 8B, which shows an exemplary plot of the output power of the RF power module as a function of V_{CTRL} for several exemplary ambient temperatures.

FIG. 8C is a simplified schematic diagram of a system for extracting a behavioral model using a loadpull measurement system.

FIG. 9A graphically depicts an exemplary power sweep data of a DUT, with the transducer gain G_{T} measured as a function of power available at the load. FIG. 9B depicts an exemplary instantaneous transfer function in the voltage domain, with the output voltage V_{O} as a function of the input voltage Vᵢ. FIG. 9C is a simplified flow diagram illustrating an exemplary process for obtaining the instantaneous transfer function of a DUT.

### DETAILED DESCRIPTION

In the following detailed description and in the several figures of the drawing, like elements are identified with like reference numerals.

“Loadpull” is a colloquial term that refers to measurement of transistor electrical characteristics by presenting a controlled impedance at either of the two transistor ports (assuming here that the transistor shares a common reference with both the input and output, hence making it a two-port device), or both simultaneously. By loadpull it is implied that impedance control be done at any frequency in which there is energy present. While this is most often the fundamental frequency, sub-harmonic and harmonic loadpull can be done as well. In addition, loadpull generally allows for varying other control parameters applied to the DUT, such as power, modulation, bias, frequency, and temperature.

Loadpull was traditionally done using manual impedance control devices, for example, manual tuners, and was slow, cumbersome, and prone to error. It was difficult to know the impedance presented to the DUT a priori, so the user generally was required to make a measurement, remove the tuner, and measure the impedance the tuner had presented.

Fully automated loadpull revolutionized transistor characterization in terms of accuracy, speed, volume and type of data, and cost. Using an automated impedance control device, such as an automated tuner, which is a priori characterized, known impedances can be presented to a DUT, data collected, and then displayed. Special software controls both the tuners and the equipment necessary to control the DUT and collect the data. Automated loadpull is now the standard for characterizing transistors for noise and power operation, finding application in semiconductor process evaluation, low-noise design, PA design, and final-test. An exemplary automated loadpull system is the MT 980G17 automated tuner system (ATS) marketed by the assignee of this application, Maury Microwave Corporation, Ontario, Calif. This exemplary system is typically configured to include two MT 981 tuner systems, a controller software package (MT 993A), and a tuner controller MT 986C.

Loadpull generally acquires voluminous data, primarily to enable trends, or more specifically, gradients, to be identified amongst critical performance parameters. Very often the performance parameters are mutually exclusive. For example, there is a very well understood physical reason why power and efficiency are mutually exclusive. Hence, the data allows the user to identify regions, with respect to impedance, and any of the other control parameters, where performance criteria are met simultaneously (or not, as the case may be).

The practice of loadpull is subject to the user's needs, in terms of what is usually done with the measured data. For those applications in which the user is interested in determining the optimum impedances, and other control variables, then most of the data that the loadpull system provided is discarded, since it is used only to guide the user to the final optimum solution. More significantly, the final data that is obtained, which is source and load impedance and control variables, is incompatible with a standard CAD design flow (save for the exception of using this data in a linear simulation, which may not be useful) since it is inherently incompatible with standard solution algorithms, e.g. time-domain, harmonic-balance, and time-varying harmonic-balance. Moreover, the data represents only the characteristics of the DUT at the specific source and load impedance points, and control variables, at which the loadpull was done. Although there may have been many impedance points used to take data, they were used to establish trends: once optimum source and load impedances have been identified, then this represents the desired optimum operating condition.

These constraints pose a problem for designers who might wish to integrate loadpull data within a standard CAD design-flow and make it compatible with the solution algorithm(s) for whatever reason, might wish to use CAD tools to design circuitry around the transistor to achieve a desired performance, including matching networks, bias networks, and additional stages for increased amplification or power levels, might wish to analyze the effect of process changes or external circuitry changes on the DUT (e.g. corner simulation) using CAD tools, or might wish to embed a model of the DUT in a top-level system simulation using CAD tools.

Exemplary embodiments described herein include an apparatus and method that may retain the data taken with loadpull, process the data to enable interpolation over various dimensions (i.e. fit a model, but not necessarily an equivalent circuit model, since emulating observed behavior is a primary interest, not necessarily modeling what is happening inside the transistor, on the die, in the package, or within the system). The models may be compatible with standard CAD design-flow and solution algorithms.

Exemplary embodiments of the present invention include an apparatus and a method. An exemplary embodiment of an apparatus includes a means of presenting a controlled impedance to the DUT. Generally, impedance control may be done with a tuner, although this is not the only type of apparatus which can perform this function. Exemplary tuners include the Maury Microwave MT 981, MT 982 and MT 983 tuners. Other types of apparatus for presenting a controlled impedance to the DUT include a test fixture with adjustable capacitor and inductor elements to vary or set the impedance. In addition, the apparatus may include hardware to collect the data, this typically being RF/microwave test and measurement equipment. There may also be hardware to run the impedance control mechanism.

An exemplary embodiment of a method allows data acquired in the normal process of loadpull to be converted into a model and inserted into a standard CAD design-flow, e.g., for use in a simulation for design and analysis. There may be additional data, not necessarily part of classical loadpull, that is also collected and used for model extraction. A model extraction technique employs a stimulus used to excite the DUT with a pre-defined signal (or signals), and collects data using impedance control, and optionally other hardware, processes the data, and creates a DUT model.

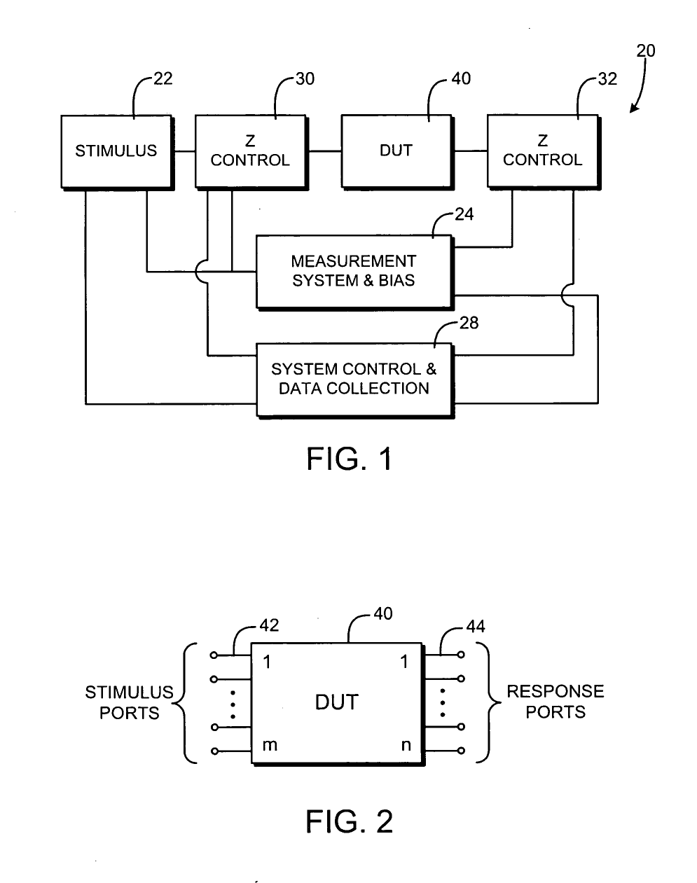

FIG. 1 illustrates a simplified schematic block diagram of an exemplary embodiment of a generalized impedance control apparatus (e.g. a loadpull system) 20 including stimulus hardware 22, measurement system 24, control system 26, data collection system 28, source impedance control 30, output/response impedance control 32, and the DUT 40. In an exemplary embodiment, the stimulus hardware 22 may be an RF signal generator or source; an exemplary commercially available stimulus generator is the Agilent E4438C system. The functions of the source impedance control system 30 and the output impedance control system 32 can be performed by respective tuner systems, e.g. the Maury Microwave MT 981 tuner, which may be part of an automated loadpull system. The measurement and bias system 28 may include a bias system for biasing the DUT and measuring parameters such as current. The bias functions can be performed, by way of example only, by an Agilent 6624 power supply for the case in which the DUT is a transistor system. The measurement system may include a power meter, for example, such as the Agilent E4416A power meter. In an exemplary embodiment, the DUT 40 can be an arbitrary system, e.g. a semiconductor device, an RF power module for a cellular telephone, a transistor or system, where “transistor” can be anything from a unit-cell to a packaged transistor with internal matching, and where “system” can be any type of connection of a plurality of transistors with possibly other elements or components. The DUT may also be passive. The stimulus hardware 22 establishes the frequency parameter, i.e. varying the frequency as a stimulus parameter. The frequency range will be dependent on the particular DUT. The automated tuners may be operable over a broad frequency range, by way of example only, the Maury Microwave MT982 tuner is operable over a 800 MHz to 8 GHz frequency range. Higher frequencies or lower frequencies, even down to baseband, may also be employed, depending on the DUT and the measurement requirements. Source power is applied to the impedance control 30 and the source impedance, established by the impedance control system 30, is used as an extraction space parameter. A bias may be applied to the DUT 40. The load impedance is established by the impedance control system 32.

Consider now a user-defined extraction space, i.e. a combination of stimulus such as an RF signal and any modulation signal on the RF signal, source power range, operating frequency range, bias range (In the event that the DUT is a system, for example a Power Amplifier Module, then by bias is meant any of the control signals to properly configure the DUT for a prescribed operation, in addition to standard bias), and source impedance domain and load impedance domain. The model extraction technique is operable over non-50 Ohm impedance domains, as well as conventional 50 Ohm impedances. This extraction space constitutes the range of each of the variables over which a DUT model is to be extracted. Note that the foregoing list is not meant to be exhaustive, exclusive, or inclusive, as there may be other dimensions to the extraction space the user may wish to include.

An exemplary embodiment of the control system 28 may accept these extraction-space data and drive the stimulus hardware 22, the impedance control systems 30 and 32, and the measurement system 24 in order to collect data representing a description of the operating properties of the DUT as a function of the various conditions prescribed over the extraction space.

Following the data collection, a model is extracted using what is commonly referred to as a behavioral model. What is meant herein by “behavioral model” is that the fundamental behavior of the DUT is described by establishing a relation between the stimulus ports and the response ports, without necessarily understanding what is happening inside the DUT “box.” FIG. 2 illustrates an exemplary embodiment of a DUT 40 with m stimulus ports 42 and n response ports 44. Note that the stimulus and response ports need not be distinct; it is possible, for example, that at a port, the stimulus could be voltage and the response could be current. While reference may be made to voltage and current, since these are physical quantities commonly measured, temperature or power could be a stimulus or response parameter. In addition, voltage or current could be an electrical analog of some other parameter, such as temperature.

Behavioral modeling, as it has been applied to RF/Microwave transistor modeling and system modeling, makes no presumption of impedance independence. This is a direct consequence of the fact that the constitutive relationships between the DUT port stimuli and responses shown in FIG. 2 are a function of the external conditions presented to them. Thus, when a behavioral model is extracted, it may be meaningful at a fixed combination of source and load impedance only, in addition to impedances where there is significant energy, e.g. harmonics.

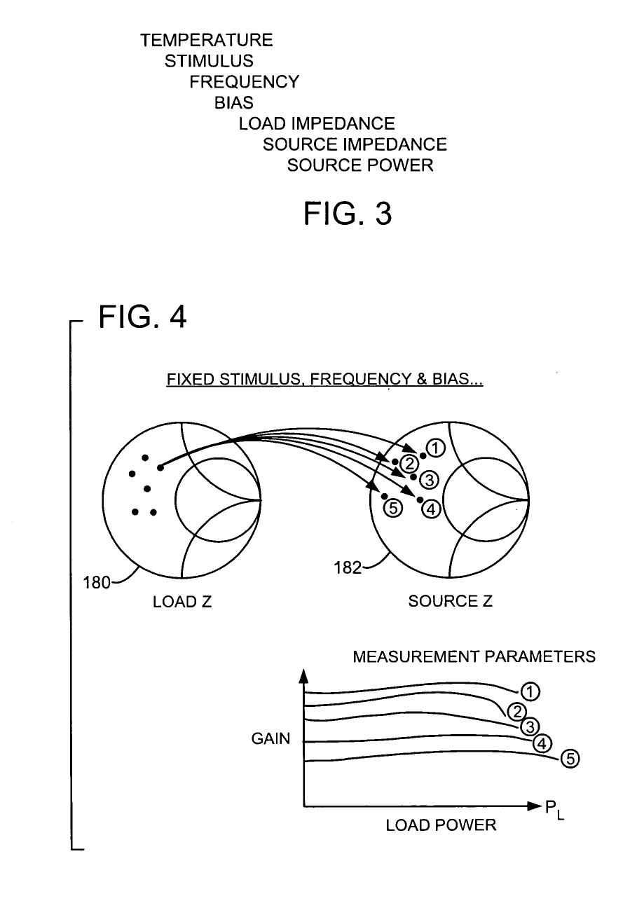

One exemplary embodiment of a method may extract a behavioral model at a single impedance point (source and load). Another exemplary embodiment of a method automatically extracts a behavioral model at various combinations of source and load impedance, in addition to other control parameters deemed useful for accurate and precise modeling. Consider as an example FIG. 1, which shows one possible exemplary configuration for implementing an impedance control and behavioral model extraction apparatus and method. Using classical loadpull as a basis for the present example, the user will typically start the loadpull process by defining an extraction-space, which usually includes specifying stimulus, frequency, a nominal bias, a source power range, source impedance range, and load impedance range. The order may not be particularly important, although it will affect the time to collect the data, since some parameter sweeps are faster than others. One exemplary method to achieve this using computer control and data collection is to use the ‘Sweep Plan’ feature in the ATS software available from Maury Microwave, Inc., the assignee of this application. The “Sweep Plan” feature is described, for example, in the Operating Manual for the Automated Tuner System PC Based Application Software, Revision 3, MT 993-2, Maury Microwave Corporation, the entire contents of which are incorporated herein by reference. FIG. 3 shows a typical extraction-space protocol, in essence being a nested loop. This figure illustrates several exemplary parameters, temperature, stimulus, frequency, bias, load impedance, source impedance and source power. A given one of these parameters may be varied by the loadpull system while the remaining parameters are held constant, and measured data collected. Thus, for the example of FIG. 3, source power is varied over its range within the extraction space while all other parameters are held constant and data is measured and stored. Next the source impedance is varied over its range within the extraction space while all other parameters are held constant and data collected. The process continues for all parameters until data has been collected over the extraction space. The order of the measurements may be varied, e.g., the source impedance may be varied through its range first before source power. The time-frequency characteristics of the stimulus, i.e. the input signal, namely its time rate of change, will directly impact the electrodynamic and thermodynamic modes that are excited in the DUT. In general, the stimulus may be chosen such that the modes of interest to the user are excited.

The selection of the stimulus may be dictated by the nature and generality of the model extraction. For example, for a CW (constant wave) application, where thermal and electrical transients may be ignored, a CW signal can be used as the stimulus. In those applications where the thermal or electrical transients may not be ignored, such as when the modulation frequency has significant energy near a thermal or electrical mode, then a stimulus similar to the modulation would be useful. In general, a stimulus will be chosen based on an understanding of the types of modes to capture in the model extraction, in order to properly model transient effects, memory effects and hysteresis effects.

Once the stimulus and frequency are fixed, then for each bias, a source power sweep may be executed for each combination of source impedance and load impedance. While harmonic and sub-harmonic impedances could also be included, they are ignored for this example; they could also be nested in the protocol of FIG. 3. FIG. 4 diagrammatically illustrates collection of an exemplary set of measurement data. For each load impedance (established by impedance control 32), a power sweep is associated with each source impedance; i.e., the stimulus source power is swept over a power range, e.g. from a low power setting to a high power setting within the extraction-space protocol. Thus, associated with each source and load impedance, there will be a power sweep that embodies the response of the DUT at that particular stimulus, frequency, and bias. FIG. 4 illustrates Smith chart representations, with chart 180 representing the chart of load impedance, with lines of constant reactance depicted, and chart 182 representing an exemplary source impedance chart, both for a fixed stimulus, frequency and bias. The gain of the DUT can be measured over power sweeps for each of exemplary points 1-5 of the chart 182, representing five different source impedances, and the respective gains are plotted in the graph of FIG. 4 as a function of the power available at the load. The gain of the DUT may also be measured over power sweeps for each of exemplary load impedances, for each source impedance, to provide additional data. The gain of the DUT is typically measured as the ratio of the power at the load to the power available at the source.

With a suitable stimulus, a very general model can result. Typically, the user may select the stimulus as described above. For example, a stimulus designed for the WCDMA cellular telephone protocol may work well for EDGE (enhanced digital GSM evolution), but the converse may not in general be true, depending on the nature of the DUT modes. DUT modes are regions of DUT operation where rapid energy storage/exchange can occur. For example, all transistors exhibit a small, but finite, time to heat as the control signal changes. The instantaneous temperature can influence the properties of the transistor, thus causing deviation from the ideal. If the modulation rate of the applied signal is on the order of the time constant of the thermal mode, then the problem becomes accentuated; modulation at a rate much higher or much lower will tend to minimize the effects of the thermal mode. A similar situation exists with electrical modes.

The identification of modes may be done by applying a stimulus with energy present near the modes of interest. For example, most thermal modes are on the order of 10 microseconds, whereas electrical modes may be much longer or much shorter, depending on the external circuitry embedding the transistor and the trap characteristics of the semiconductor process.

Following the data collection process using the apparatus, the next step in an exemplary embodiment of the method is to extract one or a group of DUT models from the measurement data collected over the extraction-space. In an exemplary embodiment, a unique behavioral model may be extracted at different combinations of the parameters within the extraction-space. Thus, there can conceivably be a large number of models, each corresponding to a unique combination of parameters within the extraction-space.

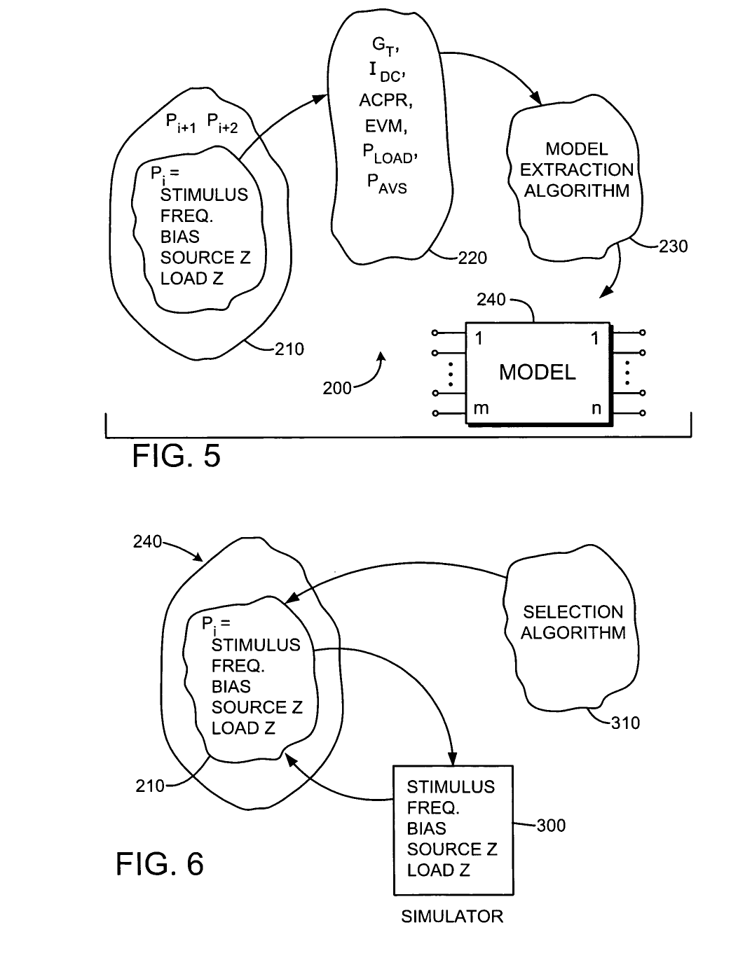

In an exemplary embodiment of a model extraction procedure, a behavioral model is adopted. While the present invention is not limited to use of behavioral models, they do have certain advantages. FIG. 5 shows an exemplary method 200 of extraction. FIG. 5 illustrates an abstract extraction-space 210, including elements that represent each of the possible combinations Pᵢ, Pᵢ₊₁, Pᵢ₊₂ . . . , e.g. for the parameter set of stimulus, frequency, bias, source impedance and load impedance. A set of data is collected for each combination of parameters, as described above regarding FIG. 4. An exemplary data set is illustrated as transducer gain G_{T}, dc component of the bias current I_{dc}, Adjacent Channel Power ratio ACPR, Power at load P_{load}, Power available at source P_{AVS}, corresponding to the ith combination of parameters Pᵢ. The transducer gain G_{T} is typically measured or computed as the ratio of P_{load} to P_{AVS}. Now, using the parameter set and the measurement data, a model is extracted by a model extraction algorithm, preferably a behavioral model. Once the model is extracted, then a multi-port representation or model of the DUT corresponding to the ith element of the extraction-space has been obtained. Note that any variety of error-reducing methods may be used to reduce the model error, including automatic methods or user-prescribed inputs.

There are a number of exemplary available model extraction methods. For example, a curve-fitting algorithm may be employed, such as a least squares method. Another exemplary method is the Fourier-Bessel approach described in “Analysis and Compensation of Band pass Nonlinearities,” A. R. Kaye et al., IEEE Transactions on Communications, Vol. COM-19, October 1972, pp. 230-238. In this exemplary method, a swept power mode, an envelope-domain instantaneous transfer characteristic is obtained using least-square fitting. This exemplary method supports capture of AM-PM (amplitude modulation to phase modulation conversion) due to decomposition of the measured gain into real and imaginary components. The effect of modes can be included using a low-pass filter(s).

In an exemplary embodiment, once an individual DUT model or an aggregate DUT model, i.e. a set of individual DUT models each corresponding to an element of the extraction-space, is extracted, it may inserted or loaded into a CAD simulator, and an algorithm is used to chose the optimum extraction-space model element that most closely resembles the actual conditions called for in the simulator. CAD simulators are well known in the art, e.g. the Agilent Advanced Design System (ADS), and the Applied Wave Research (AWR) Microwave Office CAD simulators. In the event that the closeness or error exceeds an arbitrary tolerance, then a warning is issued, notifying the user that additional data should be taken. This would occur, for example, if the user was simulating with a load impedance that was outside the range of load impedances taken in the extraction process. FIG. 6 is a diagram illustrating an exemplary way in which the model may be chosen from the extraction space. Here, the simulator 300 provides a set of parameters of interest, which may be used to select an appropriate, corresponding extraction-space 210. Measurements are taken based on the selected extraction-space, and a selection algorithm 310 selects an appropriate DUT model. Note that in some instances, it may be desirable to have the model apparatus connected to the simulator so that a model can be extracted in real-time, as the needs of the designer change during the design process.

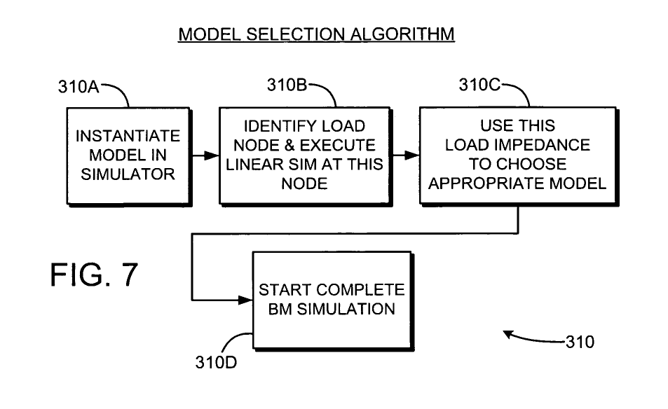

FIG. 7 illustrates an exemplary model selection algorithm 310. At 310A, the behavioral model of the DUT which has been extracted using the extraction space suitable for the simulation is instantiated in the CAD simulator. As described above, the behavioral model may be a set of models each extracted at a given point or for a given parameter in the extraction space. For example, the set of models may include models extracted over a range of output impedances presented to the DUT during data measurements, e.g. by a loadpull system. At 310B, the load node for the DUT in the simulated circuit or system is identified, and a linear simulation is executed at this node to determine the load impedance presented to the DUT by the simulated circuit or system. At 310C, this load impedance is used to select the appropriate DUT model to be used for the simulation. At 310D, the CAD simulator commences a complete simulation of a system using the selected behavioral model of the DUT.

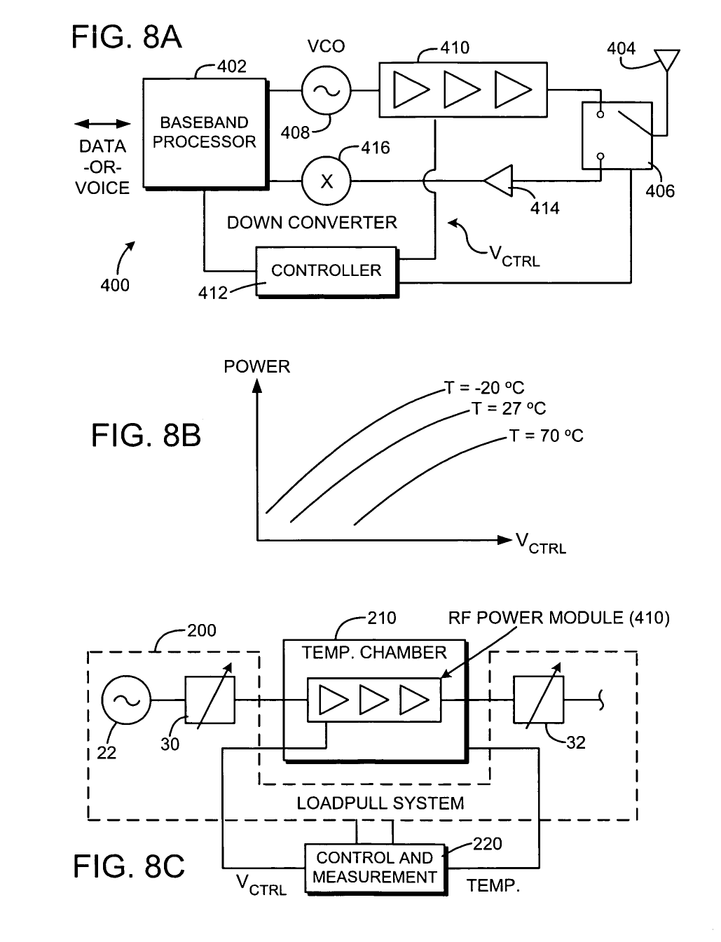

As an example of a use of a behavioral model extraction and CAD simulator use, consider a GSM telephone handset, which typically includes an RF power module. FIG. 8A illustrates a simplified schematic block diagram of a typical GSM cellular telephone handset 400. Voice or data signals are applied to or delivered from a baseband processor 402 on an input/output (I/O) side of the circuit. The opposite side of the circuit includes an antenna 304 for receiving RF cellular signals. The antenna is connected through a transmit/receive switch 406 to the transmit and receive channels. The transmit channel includes a VCO controlled by the signals from the processor 402, and an RF power module 410 which outputs RF signals with modulation bearing voice or data information. These signals are passed through the switch 406 and radiated from the antenna 404 during transmit modes. On receive, signals are passed through the switch 406 to the amplifier 414 to the downconverter 416, and the baseband signals are processed by the processor 416. A controller 412 controls the processor 402 and the switch 406. The controller 412 also controls the power module gain through a V_{CTRL} signal.

The RF power module 410 is an example of a system to be characterized by a behavioral model in accordance with the techniques described above regarding FIGS. 1-7. RF power modules for cellular telephones typically include an RF transistor circuit. The gain of the power module may be affected by the ambient temperature. This is illustrated in FIG. 8B, which shows an exemplary plot of the output power of the RF power module as a function of V_{CTRL} for several exemplary ambient temperatures.

The extraction space for the model includes an ambient temperature range. The data for the behavioral model may be obtained using an exemplary system shown in FIG. 8C. This system employs a loadpull measurement system 200, which includes a signal generator or stimulus 22, a tuner 30 to provide source impedance control, a tuner 32 to provide load impedance control. An exemplary loadpull system which may be employed is the MT4463 system available from Maury Microwave, Ontario, Calif. A temperature chamber 210 provides a means to control and vary the temperature of the DUT, in this embodiment the RF power module 410. A control and measurement system 220 controls the loadpull system and the temperature chamber setting, provides the control signal V_{CTRL} for the module, and collects the data resulting from parameter sweeps over the model extraction space.

The loadpull system 200 may be used to extract a behavioral model of the RF power module 310 over an extraction space which includes a temperature range as well as a range of the control voltage parameter. The behavioral model extracted as a function of the control signal V_{CTRL} or as a function of temperature may be inserted or instantiated in a CAD simulator for the complete GSM telephone 300, using as an example source and load impedances of 50 ohms. The CAD simulator can simulate the effect of changing V_{CTRL} or temperature on the telephone performance.

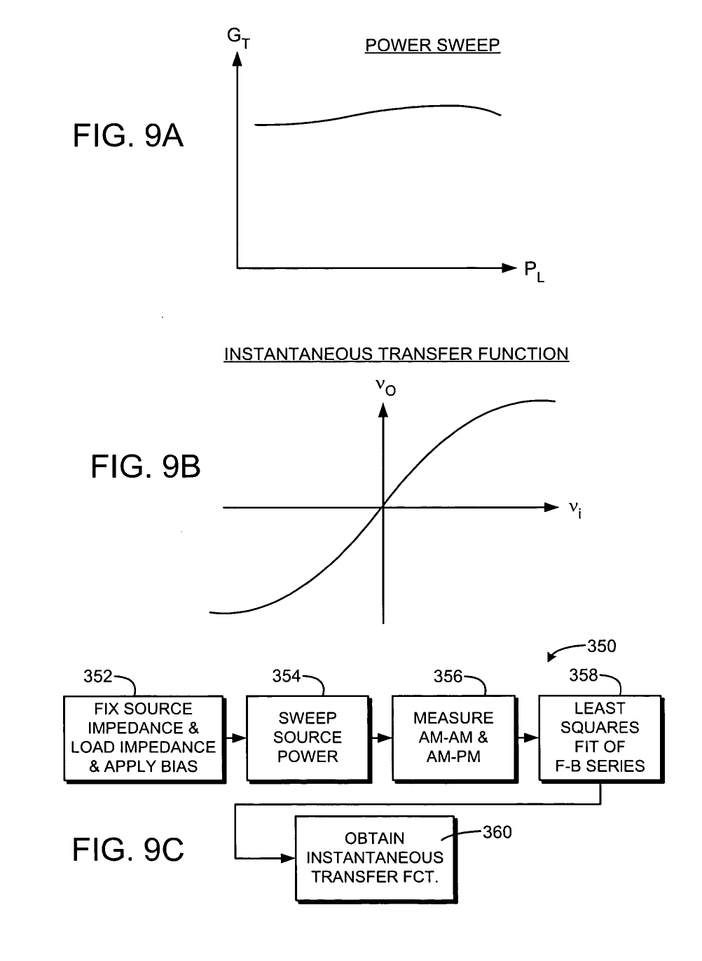

Model extraction may be conducted using any of a variety of techniques. The behavioral model may be described by a polynomial series. Some CAD simulators typically operate in the voltage domain, and so it is useful to have a model of the DUT in the voltage domain. For example, the loadpull system 200 may be controlled to collect power sweep data of the DUT, with the transducer gain G_{T} measured as a function of power available at the load, as shown in FIG. 9A. This data can be used to compute the instantaneous transfer function as illustrated in FIG. 9B, in the voltage domain, with the output voltage V_{O} as a function of the input voltage Vᵢ. For example, the method described in the Kaye et al. paper referenced above may be used for this computation. From the analysis presented in Kaye et al., it may be seen that an expansion of measured AM-AM (amplitude modulation to amplitude modulation conversion) and AM-PM power response of a DUT, using least-squares to determine the expansion coefficients, results in the same coefficients of the instantaneous envelope voltage transfer characteristic. Thus, an exemplary embodiment of the modeling process includes measuring the AM-AM and AM-PM parameters, applying least-squares to the measured response, and extracting the expansion coefficients subject to some error criteria. These same coefficients are then used in the instantaneous envelope transfer characteristic

FIG. 9C is a simplified flow diagram illustrating an exemplary process 350 for obtaining the instantaneous transfer function of a DUT such as the RF power module 410. At 352, the source and load impedances are fixed, using the input and output tuners, and a bias is applied to the DUT. The source power is swept through its range within the extraction space at 354. The AM-AM and AM-PM parameters are measured at 356. A least squares fit of the data to the Fourier-Bessel series is performed at 358, and the instantaneous transfer function is obtained at 360.

Although the foregoing has been a description and illustration of specific embodiments of the invention, various modifications and changes thereto can be made by persons skilled in the art without departing from the scope and spirit of the invention as defined by the following claims.

What is claimed is:

1. A method for extracting a behavioral model of a device under test (DUT), comprising:
defining an extraction-space protocol;
collecting a set of measurement data on the DUT in accordance with the extraction-space protocol;
extracting a group of DUT models from the set of measurement data collected over the extraction-space, each corresponding to a unique combination of parameters within the extraction-space.

2. The method of claim 1, wherein the group of DUT models comprises a group of behavioral DUT models.

3. The method of claim 2, wherein the DUT has m stimulus ports and n response ports, and behavior of the DUT is described by a relation between the stimulus ports and the response ports.

4. The method of claim 1, wherein the extraction-space protocol comprises a range of each of a set of variables over which said DUT model is to be extracted.

5. The method of claim 4, wherein said set of variables comprises stimulus, source power range, operating frequency range, bias range, source impedance range and load impedance range.

6. The method of claim 1, further comprising:
applying the group of DUT models to a computer-aided-design (CAD) simulator.

7. The method of claim 6, further comprising:
instantiating a selected one of said group of DUT models into an application for said CAD simulator.

8. The method of claim 1, wherein the DUT operates at an RF frequency.

9. The method of claim 1, wherein said collecting a set of measurement data comprises:
setting a source impedance value and a load impedance value to respective predetermined values;
conducting a first power sweep of an input stimulus signal to the DUT and measuring a first set of corresponding output power values;
setting the source impedance to a different source impedance value;
conducting a second power sweep of the input stimulus signal to the DUT and measuring a second set of corresponding output power values.

10. The method of claim 9, wherein said source impedance and said load impedance values include non-50 ohm values.

11. The method of claim 9 wherein said setting a source impedance value to a predetermined value comprises using an automated tuner system to set said source impedance value.

12. The method of claim 9, wherein said setting a load impedance value to a predetermined value comprises using an automated tuner system to set said source impedance value.

13. The method of claim 8, wherein said DUT is an RF transistor circuit.

14. The method of claim 8, wherein said DUT is an RF power module circuit for a cellular telephone handset.

15. A method for modeling a device under test (DUT), comprising:
defining an extraction-space protocol;
collecting a set of measurement data on the DUT in accordance with the extraction-space protocol;
extracting a DUT model from the set of measurement data collected over the extraction-space, corresponding to a combination of parameters within the extraction-space, said parameters comprising a source impedance or a load impedance.

16. The method of claim 15, wherein the DUT model comprises a behavioral DUT model.

17. The method of claim 15, wherein the DUT has m stimulus ports and n response ports, and behavior of the DUT is described by a relation between the stimulus ports and the response ports.

18. The method of claim 15, wherein the extraction-space protocol comprises a range of each of a set of variables over which said DUT model is to be extracted.

19. The method of claim 18, wherein said set of variables comprises stimulus, source power range, operating frequency range, source impedance range and load impedance range.

20. The method of claim 18, wherein said set of variables includes temperature.

21. The method of claim 15, further comprising:
applying the DUT model to a computer-aided-design (CAD) simulator.

22. The method of claim 21, further comprising:
instantiating the DUT model into an application for said CAD simulator.

23. The method of claim 15, wherein the DUT operates at an RF frequency.

24. The method of claim 15, wherein said collecting a set of measurement data comprises:
setting a source impedance value and a load impedance value to respective predetermined values;
conducting a first power sweep of an input stimulus signal to the DUT and measuring a first set of corresponding output power values;
setting the source impedance to a different source impedance value;
conducting a second power sweep of the input stimulus signal to the DUT and measuring a second set of corresponding output power values.

25. The method of claim 24, wherein said source impedance and said load impedance values include non-50 ohm impedance values.

26. The method of claim 25 wherein said setting a source impedance value to a predetermined value comprises using an automated tuner system to set said source impedance value.

27. The method of claim 25, wherein said setting a load impedance value to a predetermined value comprises using an automated tuner system to set said source impedance value.

28. The method of claim 23, wherein said DUT is an RF transistor circuit.

29. The method of claim 23, wherein said DUT is an RF power module circuit for a cellular telephone handset.

30. Apparatus for extracting a behavioral model from a device under test (DUT), comprising:
an automated loadpull system including a stimulus generator, means for adjustably controlling a source impedance for the DUT, means for adjustably controlling a load impedance for the DUT, and a controller for controlling operation of the loadpull system to apply a stimulus signal to the DUT while setting a source impedance and a load impedance;
means for collecting a set of measurement data on the DUT in accordance with an extraction-space protocol;
means for extracting a DUT model from the set of measurement data collected over the extraction-space

31. The apparatus of claim 30, wherein the means for extracting the DUT model comprises a curve fitting algorithm for curve fitting to said set of measurement data.

32. The apparatus of claim 30, wherein the curve fitting algorithm is a least squared algorithm.

33. The apparatus of claim 30, wherein the loadpull system further includes a bias control means for adjustably applying a bias signal to the DUT through a bias range within the extraction-space protocol.

34. The apparatus of claim 30, further including a temperature chamber for setting an ambient temperature to which the DUT is subjected in a test mode to a plurality of ambient temperatures within the extraction-space protocol.
